(19) United States
(12) Patent Application Publication
(10) Pub. No.: US 2024/0077587 A1
(43) Pub. Date: Mar. 7, 2024

(54) LIDAR RECEIVER

(71) Applicant: TTP Plc., Royston (GB)

(72) Inventors: Tom JELLICOE, Royston, Hertfordshire (GB); Alex CONEY, Royston, Hertfordshire (GB); Neil GRIFFIN, Royston, Hertfordshire (GB)

(21) Appl. No.: 18/039,885

(22) PCT Filed: Dec. 3, 2021
(86) PCT No.: PCT/GB2021/053168

§ 371 Date: Jun. 1, 2023

(30) Foreign Application Priority Data
Dec. 4, 2020 (GB) 2019146.6

(51) Int. Cl. G01S 7/481

(52) U.S. Cl. CPC G01S 7/4816

(57) ABSTRACT

A receiver for a lidar system. The receiver comprises a monolithic block of optically transmissive material, the block shaped to define a planar light receiving surface, a first reflective surface and a second reflective surface positioned adjacent to the light receiving surface. The surfaces are positioned such that light from a distant on-axis source passing through the light receiving surface passes through the block to the first reflective surface and is reflected thereby towards the second reflective surface and in turn reflected thereby to pass through a receiving aperture formed in the first reflective surface and to come to a focus at or after the receiving aperture.

### RELATED APPLICATION

The present application is a national stage application under 35 U.S.C. § 371 of International Application No. PCT/GB2021/053168, filed Dec. 3, 2021, which claims priority to Great Britain Patent Application No. 2019146.6, filed Dec. 4, 2020. The above referenced applications are hereby incorporated by reference.

### FIELD

The present invention relates to a receiver for a lidar system. It has particular benefits in systems which require low cost components and space constraints, such as those employed in autonomous vehicles.

Lidar systems are employed in a number of fields, from weather monitoring satellites through to detection systems for automated machinery and autonomous vehicles. Such lidar systems are often complex due to the high mechanical tolerances that are often required for their optical systems. Furthermore, they often have requirements in terms of their size and robustness over significant temperature ranges which can make them challenging to produce at a cost that makes them viable for many applications, particularly high volume systems such as are required for automated machinery and for autonomous vehicles.

One component of such lidar systems that presents particular challenges is the receiver for the lidar sensor. For mechanical spinning lidar, each optical channel of a lidar system requires a sensor that has a narrow field of view and a long range. Such receivers are often provided by using a telephoto lens construction with two lens groups, one negative and one positive. To achieve the sensitivity required to operate at long range, these optical arrangements need to have a large aperture. This is difficult to do with a complex telephoto lens system if there are space and cost constraints. Some systems are further complicated by the need not to be sensitive to temperature variations and a need also to be assembled with a high degree of optical accuracy. The arrangement of the present invention seeks to address some of these problems.

According to the present invention there is provided a receiver for a lidar system, the receiver comprising a monolithic block of optically transmissive material, the block shaped to define a planar light receiving surface, a first reflective surface and a second reflective surface positioned adjacent to at the light receiving surface, the surfaces positioned such that light from a distant on-axis source passing through the light receiving surface passes through the block to the first reflective surface and is reflected thereby and focussed on totowards the second reflective surface and in turn reflected thereby to focus on and pass through a receiving aperture formed in the first reflective surface and to come to a focus at the receiving aperture or after passing through the receiving aperture.

With the arrangement of the present invention, by providing a monolithic block construction it is possible to provide a sensor that is simple to manufacture and yet is resistant to temperature variations as thermal expansion and contraction affects both the mirror focal lengths and the propagation distances by the same amount. Furthermore it can ensure a low alignment sensitivity assembly. In addition, it allows for the bonding of any sensor element directly onto the receiver component to simplify assembly and ease optical alignment of the total optical receiver system. It also reduces the overall number of components in the optical system when compared to refractive telephoto designs, reducing overall costs. As discussed above, one of the requirements is often the provision of a narrow field of view which requires a long focal length, increasing the size of the component as a long optical path is required. This is particularly the case if a large diameter is needed for light collection efficiency. With the arrangement of the present invention, the optical path folds back on itself within the block which substantially reduces overall system length. Furthermore, the reflective arrangement allows for much more optical power without significant aberrations being introduced, giving it a far better light collection for a given focal length. To accommodate detectors with linear arrays, the present invention could be replicated to form a single monolithic array of receivers to match the arrangement of the detectors. This single monolithic component would substantially reduce the cost of an array of sensors, whilst simplifying alignment. An example of the present invention will now be described with reference to the accompanying drawings, in which:

### BRIEF DESCRIPTION OF THE DRAWINGS

FIG. 1 is a side cross-sectional view of a lidar system receiver of the present invention;

FIG. 2 is a side perspective view of the receiver of FIG. 1;

FIG. 3 is a side cross-sectional view of the component of the earlier figures with an optical sensor combined therewith; and

FIG. 4 is a schematic diagram showing a lidar system with the receiver of the present invention incorporated therein.

### DETAILED DESCRIPTION OF THE INVENTION

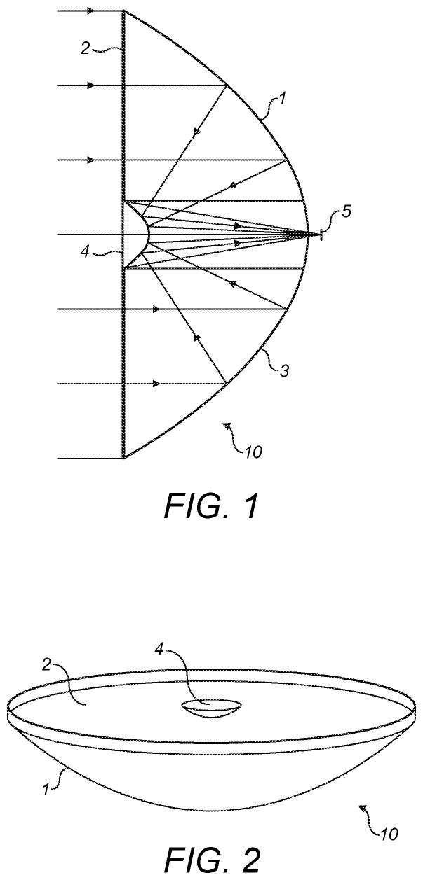

Referring to FIG. 1, a receiver 10 according to the present invention is formed from a monolithic block 1 which comprises a material which is transmissive at the wavelength of the light to be received. If the light to be received is in the ultraviolet, visible or near-infrared fields then transmissive plastic polymers (eg. poly(methyl methacrylate) or cyclic olefin copolymer) or moulded glasses can be used. For the mid-infrared range materials such as calcium fluoride or ClearTran® can be used. The choice of glass, or indeed any optically-transmissive medium, and selection of substrate may also be influenced by a number of other factors including weight, transmissibility and the suitability of adhering an appropriate reflective layer as discussed below.

The block 1 has a generally planar light receiving surface 2 which receives the light and allows light transmission therethrough to pass to a rear curved reflective surface 3 which has mirror material applied thereto. That mirror material may be formed from sputtered metal coating or other similar coating. The coating material may be selected based on the wavelength to be received or to aid manufacture or both. For example for infrared gold is an ideal material and can have the added benefit, when used with polymer-based substrates, of not requiring a binding layer. For visible light, gold is non-ideal reflector and a different metal is preferable for the reflective surface 3. This may require a binding layer formed from titanium or molybdenum if a polymer-based substrate is being used, which in turn can reduce the reflectance. A glass substrate can be used for visible light with an aluminium layer sputtered directly on to it. If sputtering is employed then laser cut masks can be employed to ensure accurate manufacture and accurate aperture creation.

Formed in the centre of the planar surface 2 is a second curved reflective surface 4 which also has mirror material formed thereon and which is generally shaped to define a convex hyperbolic mirror. Aligned with the axis of the second reflective surface 4 is an aperture 5 in the first reflective surface 3.

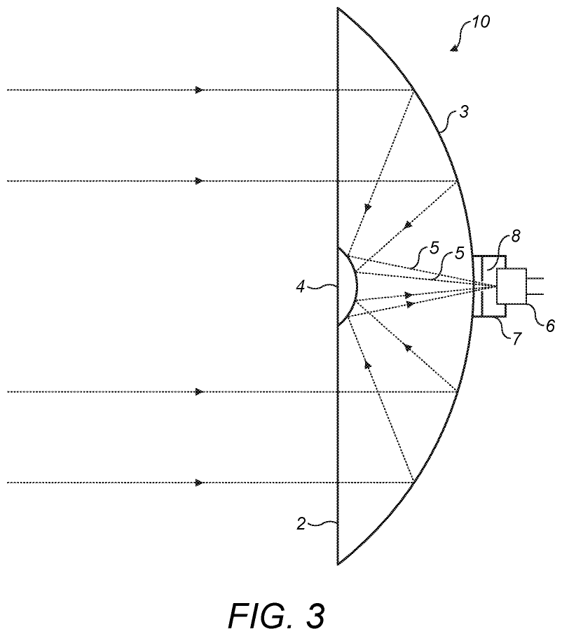

In operation light passes through the receiving surface 2, is reflected by the first reflective surface 3 and focussed on to the second reflective surface 4. The receiving surface 2 may have an anti-reflective coating, not shown. The device as a whole, or at least the reflective surface 3, can also have a protective coating, such as one formed from silicon dioxide, to increase the robustness of the device. The light is reflected again and focussed through the aperture 5. A detector 6 may be bonded onto the surface at the position of the aperture 5 to detect the received light for processing by the lidar system. The detector 6 is shown in FIG. 3.

The detector 6 can be abutted tightly directly to the second reflective surface 3, such that the surface of the detector is in optical communication with the aperture formed within the second surface 3. This requires merely that the aperture is formed with sufficient accuracy, which is within the scope of existing moulding and coating/deposition techniques.

Alternatively, the monolithic block 1 can be extended to form a recess into which the detector 6 is assembled and fixed either by gluing, cementing, compression fit or other retaining methodology. If a very low cost monolithic block 1 is desired, a larger aperture 5 may be created, with an intermediate component 7 housing an accurately machined second aperture 8, and the detector 6 is mounted directly to, or inserted into recess of, said intermediate component 7. This last, composite, construction is illustrated in FIG. 3.

As a person skilled in the art will appreciate, this configuration is a Cassegrain reflector arrangement often employed in telescopes and other devices but differs through use of the monolithic block structure. It will be appreciated that with such an arrangement the size of the receiver optics can also be directly scaled. This decreases the angular field of view whilst maintaining the f-number of the system. It will be appreciated that to maximise the aperture with a given field of view, the f-number of the design is minimised, where possible. It will also be appreciated that other mirrored surface shapes, such as elliptical or rectangular mirrors could be used to produce different aperture geometries whilst employing the same concept to optimise receiver geometry and still maintaining a minimal space envelope for the overall receiver structure.

As can also be appreciated, the configuration of the present invention can be employed to produce a combined receiver and transmitter arrangement by replacing any detector at the aperture 5 with a combination of a detector 6 and a transmitter 6 (FIG. 3). Such a configuration could be achieved by a beamsplitter (not shown) to ensure both components can be at the focal position. The detector 6 could simply be replaced with a transmitter only. It will also be appreciated that, whilst the above example discusses the direct bonding of a detector 6 to the aperture 5, the detector 6 could be connected via an optical fibre or other optical transmission structure, such as a reflector to optimise the space envelope over the overall sensor system comprising the receiver 10 to provide a periscope-style optical delivery mechanism to the end detector 6 or indeed to provide light to an array of sensors within the overall structure. It is also possible to employ a sensor 6 which is an array detector to provide imaging capabilities. This array detector 6 might be a conventional image sensor (CMOS or CCD as known in the art) but is preferably an array of photodiodes, effectively creating an imaging array with a very large pixel size.

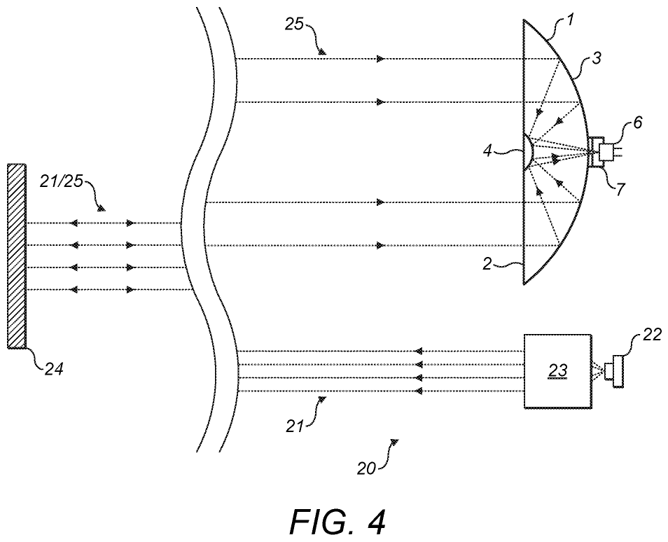

FIG. 4 shows how the receiver of FIGS. 1 to 3 can be employed within a lidar system 20. The lidar emission 21 for the system is generated by a laser emitter 22 and passes through transmission optics 23 before reflecting off a target surface 24. The return light 25 enters the lidar receiver 10, reflecting off the two surfaces 3,4 before being collected onto the detector 6.

As will be understood from the above, the lidar receiver 10 of the invention, by being formed from a monolithic block of material, is robust and compact whilst providing the desired field of view, range, and light collecting capability needed for lidar systems.

1. A receiver for a lidar system, the receiver comprising:
a block of optically transmissive material, the block having a monolithic shape comprising:
a planar light receiving surface,
a first reflective surface, and
a second reflective surface positioned adjacent to the planar light receiving surface, wherein the block is configured to:
receive light from a distant on-axis source at the planar light receiving surface,
transmit the light through the block to the first reflective surface;
reflect the light from the first reflective surface towards the second reflective surface,
reflect the light from the second reflective surface through a receiving aperture formed in the first reflective surface, and
focus the light at or after the receiving aperture.

2. The receiver of claim 1, wherein a reflective material is selectively applied to portions of the first reflective surface and the second reflective surface.

3. The receiver of claim 1, wherein the optically transmissive material is of one of glass, plastic polymer, Poly Methyl MethAcrylate, polystyrene, polycarbonate, COC, or COP, Calcium fluoride or ClearTran®.

4. The receiver of claim 1, further comprising an anti-reflective surface formed on the planar light receiving surface.

5. The receiver of claim 1, wherein the first reflective surface defines a concave parabolic mirror and the second reflective surface defines a convex hyperbolic mirror.

6. The receiver of claim 1, wherein the first reflective surface has a metallic layer attached thereto.

7. The receiver of claim 6, wherein the metallic layer is gold.

8. The receiver of claim 1, further comprising a detector bonded to the block at the receiving aperture.

9. The receiver of claim 8 wherein the detector is an array of light receivers.

10. A lidar system comprising an array of receivers, each receiver comprising:
a block of optically transmissive material, the block having a monolithic shape comprising:
a planar light receiving surface,
a first reflective surface, and
a second reflective surface positioned adjacent to the planar light receiving surface,
wherein the block is configured to:
receive light from a distant on-axis source at the planar light receiving surface,
transmit the light through the block to the first reflective surface;
reflect the light from the first reflective surface towards the second reflective surface,
reflect the light from the second reflective surface through a receiving aperture formed in the first reflective surface, and
focus the light at or after the receiving aperture.

11. (canceled)

12. The lidar system of claim 10, wherein the array of receivers is formed from a single monolithic block.
